(19) United States
(12) Patent Application Publication
(10) Pub. No.: US 2010/0017605 A1
(43) Pub. Date: Jan. 21, 2010

(54) METHOD OF DETECTING AN ABNORMAL USE OF A SECURITY PROCESSOR

(76) Inventors: Quentin Chieze, Paris (FR); Alain Cuaboz, Paris (FR); Alexandre Giard, Saint Contest (FR); Olivier Granet, Suresnes (FR); Louis Neau, Chateaugiron (FR); Matthieu Roger, Paris (FR); Bruno Tronel, Courbevoie (FR)

Correspondence Address: David A. Einhorn, Esq.;Baker & Hostetler LLP, 45 Rockefeller Plaza, New York, NY, 10111, US

(21) Appl. No.: 12/444,559

(22) PCT Filed: Oct. 25, 2007
(86) PCT No.: PCT/EP2007/061470

§ 371 Date: May 1, 2009

(30) Foreign Application Priority Data
Oct. 27, 2006 (FR) 06 54599

(51) Int. Cl. G06F 21/02; H04L 9/32

(52) U.S. Cl. 713/168; 726/23

(57) ABSTRACT

The invention relates to a method of detecting an abnormal use of a security processor invoked by at least one receiving terminal in order to control access to a scrambled digital content supplied by at least one operator to said receiving terminal.

This method comprises the following steps:
analysing security processor use during a preset observation period T_{Obs},
determining on the basis of said analysis the mean value M_{ECM} of the number of invocations per time unit of said security processor during said observation period T_{Obs},
comparing said mean value M_{ECM} with a preset threshold Sₘₐₓ, and
if the value M_{ECM} is greater than the threshold Sₘₐₓ, applying to said terminal a sanction whereof the level of severity increases progressively.

### TECHNICAL FIELD

The invention lies in the field of multimedia service access control and relates more specifically to a method of detecting an abnormal use of a security processor invoked by at least one receiving terminal in order to control access to a scrambled digital content supplied by at least one operator to said receiving terminal.

The invention also relates to a security processor intended to control access to a scrambled digital content supplied by at least one operator to at least one receiving terminal.

The invention applies irrespective of the kind of support network or content type (live TV, video on demand VOD, Personal video recorder (PVR)).

### PRIOR ART

Two unlawful uses of receiving systems that employ access control are known. The purpose of the first is fraudulently to analyse the operation of the access control processor employed in the receiver by presenting it with syntactically incorrect messages, that have a false signature for example, or are incomplete or comprise unlawful command strings, the second aims to exploit the conditional access resources of the receiving system over and above a normal authorised use. Said second use may be implemented by sharing the receiving system under consideration, and particularly its security processor (typically, card sharing), or by sharing or redistributing control words (CW sharing).

More particularly, in the event of a shared use of receiving system resources, several terminals invoke its security processor via a two-way communication network by presenting it with messages that are syntactically correct but excessive in number or diversity.

The purpose of the invention is to thwart the forms of fraud described above.

The invention has particular, but not exclusive, application when the interface between the security processor and the terminal is not protected.

The document EP 1 447 976 A1 describes a method for preventing a security processor from being shared by a number of terminals.

This method consists in measuring the times separating the presentation of two successive Entitlement Control Messages (ECM), and in verifying that the message processing timing so observed complies with pre-set rate patterns.

This method does not allow for any disturbances in the ECM message processing string since, in reality, the presentation of ECM messages to the security processor depends in particular:
on how the attachment of these ECM messages to the programs is organised, depending on whether access to a program depends on one overall access condition, or on several access conditions for each video, audio, or other component,
on the capacities offered by decoders for processing a single program or several simultaneously as in the case of multi-tuner receivers that allow one program to be recorded while another is being viewed,
on the habits of users who by repeated “zapping” cause a break in the steady ECM message processing string.

Another purpose of the invention is to overcome the drawbacks of the prior art described above.

### DISCLOSURE OF THE INVENTION

The invention recommends a method intended to allow a security processor to detect situations in which said security processor is used unlawfully over and beyond a normal authorised use.

This method comprises the following steps:
analysing security processor use during a pre-set observation period T_{obs,}
determining from said analysis the mean value M_{ECM} of the number of invocations per time unit of said security processor during said observation period T_{obs},
comparing said mean value M_{ECM} with a pre-set threshold Sₘₐₓ, and
if the mean value M_{ECM} is greater than the threshold Sₘₐₓ, applying to said terminal a sanction whereof the severity is progressively increased.

Given that the comparison step uses the mean value M_{ECM} of the number of invocations per time unit, the inventive method is statistical in nature and cannot be falsified by localised disturbances in the time structure of the programs processed and by variations in the behaviour of users.

According to one characteristic of the invention, during the observation period T_{Obs}, the mean value M_{ECM} is determined for a period of activity T_{Act} of said security processor constituted by accumulating a plurality of successive periods of activity separated by a minimum period T_{InaMin} of inactivity of said security processor.

A period of activity represents an accumulated time slot during which a security processor is invoked in continuous time spans. It must have a minimum duration T_{ActMin} so as to guarantee the significant character of the analysis. Respecting this minimum time duration means that the risk is reduced of detecting as improper a use of the security processor that is occasionally significant, even though normal and lawful.

In a particular embodiment of the inventive method, each invocation of the security processor consists in presenting to it an ECM access control message associated with the scrambled content and carrying a control word CW and the description of a least one access condition.

The analysis of security processor use comprises in this case the following steps:
determining the number N_{Ecm} of ECM messages processed by the security processor during the period of activity T_{act},
calculating the relationship M_{ECM}=N_{Ecm}/T_{Act},
comparing the relationship M_{ECM} with the threshold value Sₘₐₓ,
applying the sanction if the mean value M_{ECM} is greater than the threshold Sₘₐₓ.

In this embodiment, the analysis of security processor use comprises the following operations:

at a current date t_{c},
determining, on the one hand, the ECM messages with a distribution date contemporary with said current date t_{c} and which are presented to the security processor for a first use of a content, and on the other hand, the ECM messages with a distribution date prior to the current date t_{c} and which are presented to the security processor for re-using a content,
measuring the period of activity T_{Act} of the security processor during which it processes successive contemporary ECM messages,
counting the number N_{ECM} of contemporary ECM messages at least so long as the period of activity T_{Act} is less than a preset minimum duration T_{ActMin}.

According to the invention, on the date t_{c}, an old ECM message is determined by comparing the date t on which this ECM message was processed with the date (t_{C}−T_{Diff}), T_{Diff} representing a previously specified minimum delay separating the date t and the date t_{c}.

In an embodiment variant, counting the number N_{ECM} of successfully processed contemporary ECM messages comprises the following operations:
comparing the date t with the date (t_{C}−T_{Diff}),
increasing the number N_{ECM} if the date (t_{C}−T_{Diff}) is less than or equal to the date t, otherwise maintaining the number N_{ECM} at the current value,
increasing the period of activity T_{Act} by the value (t−t_{C}) if the date t is between the date t_{C} and the date t_{C}+T_{InaMin}, otherwise maintaining the period of activity T_{Act} at the current value.

According to another advantageous characteristic of the invention, the sanction is applied progressively in accordance with the following steps:
firstly the sanction is applied with a level of severity nᵢ a preset number of times Rᵢ,
then the sanction is applied with a next level of severity nᵢ₊₁ a preset number of times Rᵢ₊₁,
finally the maximum sanction is applied when the final level nᵢₘₐₓ is attained.

In an embodiment variant, the sanction comprises a first level consisting in temporarily blocking content reception, a second level consisting in blocking content reception with a requirement to contact the operator supplying said content, and a third level consisting in permanently blocking the reception of said content.

Preferably, security processor use is analysed by software built into said security processor.

To this end, the latter comprises:
a first module for analysing its use during a preset observation period T_{obs},
a second module for determining on the basis of said analysis the mean value M_{ECM} of the number of invocations per time unit of said security processor during said observation period T_{obs} and for comparing said mean value M_{ECM} with a preset threshold Sₘₐₓ, and
a third module for applying to said terminal a sanction whereof the level of severity progressively increases if the mean value M_{ECM} is greater than the threshold Sₘₐₓ.

### BRIEF DESCRIPTION OF THE DRAWINGS

Other characteristics and advantages of the invention will emerge from the following description, taken as a non-restrictive example, with reference to the appended figures wherein:

FIG. 1 shows diagrammatically a flow chart showing the counting of the mean value of the number of invocations per time unit of said security processor during the observation period T_{obs},

FIG. 2 shows diagrammatically the steps of analysis and sanction according to the invention.

### DETAILED DISCLOSURE OF PARTICULAR EMBODIMENTS

The invention will be described in a context of distribution by an operator of audiovisual programs protected by a conditional access system (CAS). These programmes are intended for a number of subscriber terminals each equipped with a security processor, typically a chip card.

In this context, access to a scrambled programme is controlled by the operator by making content access conditional on the terminal holding a control word CW and on commercial authorisation being available. To this end, the operator attaches to the content an access condition which must be met by the subscriber in order to be able to access said content. The control words CW and the access condition description are transmitted to the subscriber terminals via specific Entitlement Control Messages or ECM. In each terminal, the ECM messages are presented to the security processor to have their security checked. When the validity of these messages has been checked by the security processor, the access condition they carry is compared with the access titles held in a non-volatile memory of the security processor. In a way known per se, these access titles are previously received by the terminal via Entitlement Management Messages or EMM. If the access condition is met by one of these access titles, the security processor retrieves the control word CW by decryption and supplies it to the terminal, thereby allowing the content to be unscrambled. In a way known per se, the ECM and EMM messages are protected by cryptographic methods, employing algorithms and keys in order to guarantee the integrity of said messages, their authenticity and the confidentiality of the sensitive data they may be carrying, and said keys are updated in particular by security-specific EMM management messages.

It is customary to modify the random value of the control word more or less frequently, according to variable strategies selected according to the context. For example, a control word may be modified every 10 seconds, in a conventional way, in broadcast television or, in extremis, with each Video On Demand only film with individual customisation by subscriber.

The purpose of implementing the method in this context is to allow the security processor to detect any improper use to which it may have been put and to react thereto. The use under consideration here is that controlling content access, therefore represented by the processing of ECM messages by the security processor.

In order to detect an improper use, a parameter is measured statistically that represents the use of the security processor and this parameter is compared with a preset threshold value representing a normal use of said security processor.

Measuring security processor use consists in analysing the invocations of this security processor over a preset observation period T_{obs}, then in determining, on the basis of said analysis, the mean value M_{ECM} of the number of invocations per time unit during said observation period T_{obs}.

Comparing said mean value M_{ECM} with a preset threshold Sₘₐₓ allows any improper use of the security processor to be detected over the observation period T_{obs} under consideration.

The threshold Sₘₐₓ is established by examining the average behaviour of users over a significant observation period.

In order to cover at least one characteristic use cycle of the receiving terminal by the end user, a period of security processor activity is specified, during the observation period T_{obs}, representing a time slot during which the latter is invoked in continuous time spans, whether lawfully or unlawfully. A minimum period of activity T_{ActMin} is also specified representing the period to be attained by the period of activity in order to guarantee the significant character of the analysis of security processor use during the period of activity. Respecting this minimum period means that the risk can be minimised of detecting as improper a use of the card that is occasionally significant, even though normal overall. Indeed, normal use may present, typically in the event of heavy zapping, temporary invocation peaks similar to card invocation in a context of improper use.

A minimum period of inactivity T_{InaMin} is also specified representing the time that has elapsed since the last successfully processed ECM message and beyond which it is considered that the previous period of activity is ended.

Furthermore in order to determine, at a current date t_{c} corresponding to the last successful processing of an ECM message, on one hand, the ECM messages contemporary with said current date t_{c} presented to the security processor with a view to a first use of a content, on the other hand, the old ECM messages relative to the date t_{c} presented to the security processor with a view to re-using a content, the minimum period separating the date of an old ECM message from the current date is denoted by the parameter T_{Diff}, and it is considered that an ECM message is presented to the security processor with a view to re-using a content if the date of this ECM message antedates t_{c} by a period greater than or equal to T_{Diff}.

It should be noted that the date of distribution of an ECM message can be determined by different technical solutions that are known per se. For example, it is entered in this ECM message, with the access condition and the control word, by the ECM message generator, ECM-G and is extracted by the security processor when this ECM message is processed.

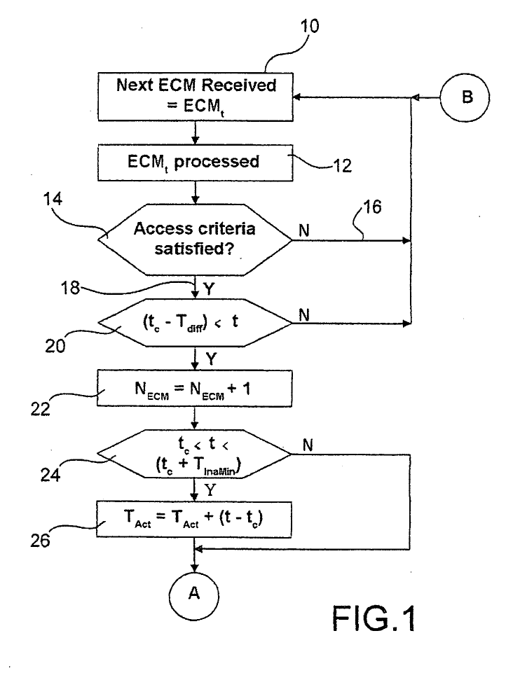

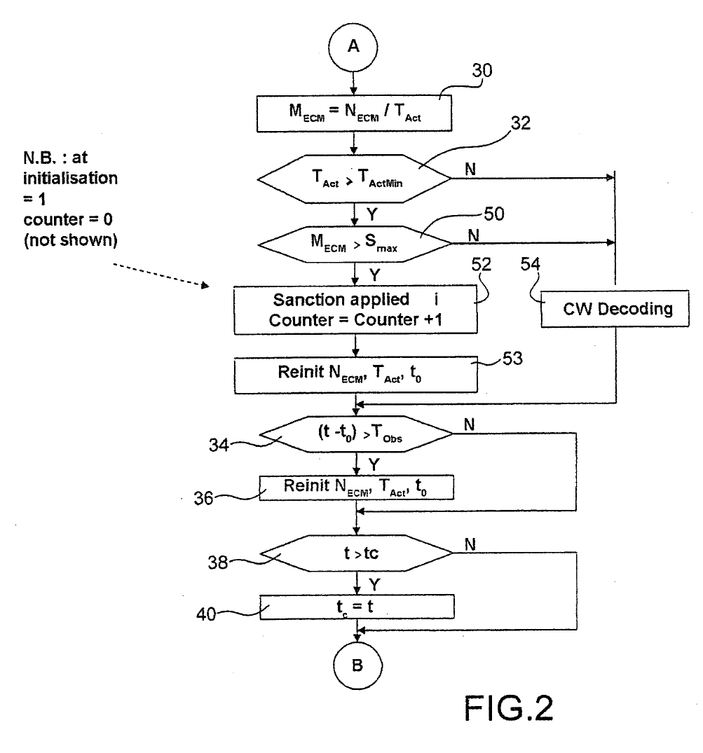

The steps in the inventive process will be described hereinafter with reference to FIGS. 1 and 2.

FIG. 1 shows the steps in counting the number N_{ECM} of ECM messages processed by the security processor during a period of activity T_{Act} and the quasi-simultaneous measurement of said period of activity T_{act}.

With reference to FIG. 1, at a current date t_{c} during an observation period T_{obs} starting at the instant tₒ, the security processor receives a message ECMₜ with a distribution date t (step 10).

At step 12, the security processor analyses the syntax, authenticity and integrity of the messages ECMₜ then determines the date t thereof and the access criteria.

At step 14, the security processor verifies the validity of the access criteria, and the authenticity and integrity of the message.

If the latter are not satisfied or if the message is not authentic or integral, the security processor analyses the next ECM message (arrow 16).

If the access criteria are satisfied (arrow 18), the security processor processes the message ECMₜ and compares, at step 20, the date t of this message ECMₜ with the date t_{c}−T_{diff} in order to determine whether the message ECMₜ is presented for a first use of the content or for a re-use after it has been recorded.

If t_{c}−T_{diff} is less than t, in other words, if the message ECMₜ relates to a first use of the scrambled program, the security processor increases the number of ECM messages processed by one unit at step 22.

If the date t of the message ECMₜ is between the dates t_{c} and t_{c}+T_{InaMin} (step 24), the security processor concludes that the previous period of activity is not yet ended and, at step 26, the duration of the current period of activity T_{Act} is increased by the duration t−t_{c}.

The period of activity T_{Act} is thus determined and the number N_{ECM} of ECM messages processed by the security processor is thus counted until the end of the observation period T_{obs}.

FIG. 2 shows diagrammatically the steps in the analysis of security processor use and sanction according to the invention.

At step 30, the security processor calculates the relationship M_{ECM}=N_{ECM}/T_{act}, wherein N_{Ecm} represents the number of ECM messages counted and T_{Act} represents the total duration of the period of activity during the observation period T_{obs}.

At step 32, the security processor checks whether T_{Act} is greater than or equal to a preset duration T_{ActMin}. The purpose of this step is to check that the period of activity T_{Act} is sufficient to guarantee the significant character of the analysis.

If T_{Act} is less than T_{ActMin}, the security processor decrypts at step 54 the control word contained in the message ECMₜ then checks at step 34 whether the period of observation T_{obs} is ended.

In the event of an affirmative reply, the security processor reinitialises (step 36) the values N_{Ecm}, T_{act}, and t₀.

In the event of a negative reply, said values are not reinitialised.

In both cases, the process is continued in step 38 which consists in checking whether the date t of the message ECMₜ is subsequent to the current date t_{c}.

If yes, the date t is assigned to the current date t_{c}.

The process is continued from step 10 of the counting (FIG. 1).

If T_{Act} is greater than or equal to T_{ActMin}, the security processor checks (step 50) whether the mean value calculated M_{ECM} is greater than the threshold Sₘₐₓ.

If yes, a sanction is applied and the number n of sanctions and/or the level of the sanction applied is increased (step 52), and the values N_{ECM}, T_{Act} and tₒ are reinitialised (step 53).

Otherwise, the control word CW is decrypted and transmitted to the terminal to allow the content to be unscrambled (step 54).

The process is then continued in step 34 which consists in checking whether the duration (t−tₒ) is greater than the duration T_{obs} of the observation period.

In the event of an affirmative reply, the security processor reinitialises (step 36) the values N_{Ecm}, T_{act}, and t₀.

In the event of a negative reply, these values are not reinitialised.

In both cases, the process is continued in step 38 which consists in checking whether the date t of the message ECMₜ is subsequent to the current date t_{c}.

If the date t of distribution of the message ECMₜ is subsequent to the date t_{c}, step 40 the date t is assigned to the current date t_{c}, and the process is continued from the counting step 10 (FIG. 1).

Sanction management at step 52 includes the increase in the number n of sanctions and/or in the sanction level. This sanction management is characteristic of the invention. Given that the method is a statistical analysis of the invocations of the security processor based on a prior modelling as will be described below, specifying a single sanction and applying it as soon as improper use is detected is excessive and may render the method ultimately ineffective. In order to benefit from the progressivity brought by statistical analysis to the detection of improper processor use, the most appropriate sanction management and therefore the one inherent in the method, is progressive management. Said management defines a number of levels of sanctions of increasing severity and applied progressively in stages.

By way of example an initial detection of improper use of the security processor causes an interruption to content access by preventing the unscrambling thereof. When this low severity sanction has been repeated a certain number of times because improper use has been confirmed; another sanction of average severity is applied which consists in temporarily blocking the terminal with a requirement for the user to contact his operator to unblock the terminal. When this second section has been applied a certain number of times, on the grounds that improper use is persisting, a final sanction of high severity is applied which consists in permanently disabling the security processor.

The process described above employs parameters which are frequently updated in a security processor memory of the EEPROM type (Electrically Erasable Programmable Read-Only Memory) so as to ensure the continuity of the analysis in the event of an interruption to the security processor power supply.

In fact, this type of memory supports a limited number of writes. So, in order to compensate this technological restriction, the parameters N_{ECM}, t_{c} and T_{Act} which are most often invoked by the calculations are stored in a non-permanent memory (RAM) and regularly saved into the EEPROM memory.

To this end, the following new parameters are specified:
the number N_{Buf} of ECM messages successfully processed since the last transfer of parameters N_{ECM}, t_{c} and T_{Act} into the EEPROM memory.
the number Nₘₐₓ representing a maximum threshold of a number N_{Buf} which triggers the update in the EEPROM memory of the parameters N_{ECM}, t_{c} and T_{Act}.

The parameters N_{ECM}, t_{c} and T_{Act} are then managed in the following way:

When the security processor is powered up, or the security processor use analysis is activated, the parameters N_{ECM}, t_{c} and T_{Act} s are created and entered with their initialisation value into the EEPROM memory if they have not already been previously.

After the security processor has been powered up, or when activating the analysis of the use of said security processor:
the parameters N_{ECM}, t_{c} and T_{Act} are loaded into the RAM memory
any implementation of these parameters is made in the RAM memory

if N_{Buf}>Nₘₐₓ, their values are additionally updated in the EEPROM memory.

In this way, each time the number of ECM messages successfully processed during the period T_{obs} increases by the preset threshold value Nₘₐₓ, the parameters N_{ECM}, t_{c} and T_{Act} are transferred into an EEPROM memory.

It should be noted that if the values N_{ECM}, t_{c} and T_{Act} are known, an ill-intentioned operator may render the method ineffective by regularly powering down the security processor. The stored values are then lost preventing security processor use from being analysed and thereby allowing a fraudster to share it with complete impunity.

To prevent the method being unlawfully circumvented in this way, one solution is to download into the security processor a new lower value of the threshold Nₘₐₓ. Another solution consists in increasing, after each power down, the values of T_{Act} and N_{ECM} and T_{Act,ini} respectively (Correction of the activity time) and N_{ECM,ini} (Correction of the number of successfully processed ECM messages).

This amounts to lowering the value of the threshold Nₘₐₓ.

In a preferred embodiment, analysis parameterisation and activation can be programmed by the operator by sending an EMM message.

This parameterisation may also be implemented in a card customisation phase.

It consists in:
choosing, from a given list, the sanction of each of the levels of average and high severity;
setting the numbers of repetitions of sanctions of low and average severity.

Additionally, said EMM message carries at least one of the following parameters:
the duration T_{obs} of the observation period,
the minimum period of activity T_{ActMin},
the delay T_{Diff},
the minimum period of inactivity T_{InaMin},
the value of the threshold Sₘₐₓ,
the value of the threshold N_{Buf}.

These parameters are complemented by the following parameters relative to the implementation of the method:

Nₘₐₓ: storage threshold expressed as a number of ECM messages,

T_{Act,ini}: Correction of the activity time expressed in seconds,

N_{ECM,ini}: correction of the number of successfully processed ECM messages,

T_{SFA}: Duration, expressed in seconds, of the non-processing of ECM under the low severity level sanction,

R_{SFA}: Number of repetitions of the low severity level sanction,

R_{SMO}: Number of repetitions of the average severity level sanction.

We describe below an example of such parameterisation resulting from a modelling of normal use of the security processor.

It is considered that the behaviour of a user varies depending on the day of the week, but is repeated from one week to the next.

The analysis is based furthermore, on the following assumptions:
Assumption of zapping: 1 additional ECM message at each zapping,
Low Level Zapping: 20 additional ECM messages per hour, i.e. 1 every 3 minutes,
Medium Level Zapping: 60 additional ECM messages per hour, i.e. 1 per minute,
Normal Zapping: 120 additional ECM messages per hour, i.e. every 30 seconds,
Excessive Zapping: 1,000 additional ECM messages per hour, i.e. every 3 seconds.

In the embodiment example which will be described, the analysis was tested over an observation period of 7 days, then over an observation period of 15 days. In the case of programs comprising several scrambled components, only the principal ECM path, relating to video, for example, was counted.

The following values are then set:
Minimum inactivity time: 15 seconds
Deferment delay: 5 minutes,
Encryption period: 10 seconds,
The number of tuners in the receiving system is limited to 2, allowing simultaneous access to two contents, one in direct display, the other recorded on the terminal's bulk store.
Observation period: 7 to 14 days, Based on the above assumptions and on known uses, a number of profiles of lawful use and unlawful use of a receiving system have been drawn up. To be able to discriminate between these two categories of use profiles, modelling leads to the following values being determined of the parameters T_{obs}, T_{ActMin} and S_{Max}:
The observation time T_{obs} is 14 days, i.e. 1209600 seconds.
An invocation of 0.22 ECM per second allows the discrimination required with a margin of security which provides a wide latitude of behaviour for the lawful user of a receiving system with one or two tuners. The maximum lawful invocation S_{Max} is set at this value.
The minimum activity time T_{ActMin} is set at 30 hours, i.e. 108000 seconds.

The inventive method is implemented by a security processor comprising:
a first module for analysing its use during a preset observation period T_{obs},
a second module for determining from said analysis the mean value M_{ECM} of the number of invocations per time unit of said security processor during said observation period T_{obs} and for comparing said mean value M_{ECM} with a preset threshold Sₘₐₓ, and
a third module for applying to said terminal a sanction whereof the level of severity progressively increases if the mean value M_{ECM} is greater than the threshold Sₘₐₓ.

This security processor employs software comprising:
instructions for analysing the use of said chip card by said terminal over a preset observation period T_{obs},
instructions for determining from said analysis the mean value M_{ECM} of the number of invocations per time unit of said chip card by said terminal during said observation period T_{obs} and for comparing said mean value M_{ECM} with a preset threshold Sₘₐₓ, and
instructions for applying to said terminal a sanction whereof the level of severity progressively increases if the mean value M_{ECM} is greater than the threshold Sₘₐₓ.

The method has been described in the situation where the ECMs taken into account in counting and analysis are successfully processed ECMs, i.e. recognised as being syntactically correct, authentic, integral and satisfied by ad hoc entitlements to allow access to contents. As an alternative, the method may also be implemented by taking into account ECMs recognised as being erroneous by the security processor particularly as regards syntax, authenticity and/or integrity. This means that brute force attacks by reiterated presentations of deliberately incorrect ECMs can be significantly integrated into the analysis of improper processor use. In this event step 14 in figure is not performed and the method in FIG. 1 is continued in step 20.

1. Method of detecting abnormal use of a security processor invoked by at least one receiving terminal in order to control access to a scrambled digital content supplied by at least one operator to said receiving terminal, method characterised in that it comprises the following steps:
analysing security processor use during a preset observation period T_{obs},
determining on the basis of said analysis the mean value M_{ECM} of the number of invocations per time unit of said security processor during said observation T_{obs},
comparing said mean value M_{ECM} with a preset threshold Sₘₐₓ, and
if the mean value M_{ECM} is greater than the threshold Sₘₐₓ, applying to said terminal a sanction whereof the level of severity increases progressively.

2. Method according to claim 1 wherein, during said observation period T_{obs}, the mean value M_{ECM} is determined during a period of activity T_{Act} of said security processor constituted by accumulating a plurality of successive periods of activity separated by a minimum period T_{InaMin} of inactivity of said security processor.

3. Method according to claim 2, characterised in that each invocation of the security processor consists in presenting it with an ECU access control message associated with the scrambled content and carrying a control word CW and the description of at least one access condition in order to supply the terminal with the control word for unscrambling the content,
and In that the analysis of security processor use comprises the following steps:
determining the number N_{ECM} of ECU messages processed by the security processor during the period of activity T_{act},
calculating the relationship M_{ECM}=N_{ECM}/T_{act},
comparing the relationship M_{ECM} with the threshold value Sₘₐₓ,
applying the sanction if M_{ECM} is greater than Sₘₐₓ.

4. Method according to claim 3, wherein security processor use is analysed by software built into said security processor.

5. Method according to claim 1, wherein said sanction is applied progressively in accordance with the following steps:
firstly the sanction is applied with a level of severity nᵢ a preset number of times Rᵢ,
then the sanction is applied with a next level of severity nᵢ₊₁ a preset number of times Rᵢ₊₁,
lastly the maximum sanction is applied when the last level nᵢₘₐₓ is attained.

6. Method according to claim 5, wherein said sanction comprises a first level consisting in temporarily blocking content reception, a second level consisting in blocking content reception with a requirement to contact the operator supplying said content, and a third level consisting in permanently blocking reception of said content.

7. Method according to claim 3, wherein the analysis of security processor use comprises the following operations:
at a current date t_{c},
determining on the one hand, the ECM messages with a distribution date contemporary with the current date t_{c} and which will be presented to the security processor for a first use of a content, on the other hand, the ECM messages with a distribution date which antedates the current date t_{c} and are presented to the security processor for re-using a content,
measuring the period of activity T_{Act} of the security processor during which it processes successive contemporary ECM messages,
counting the number N_{ECM} of contemporary ECM messages at least so long as the period of activity T_{Act} is less than a preset minimum duration T_{ActMin}.

8. Method according to claim 7, wherein, at the date t_{c}, an old ECM message is determined by comparing the distribution date t of this ECM message with the date (t_{c}−T_{Diff}), T_{Diff} representing a previously specified minimum delay separating the date t and the date t_{c}.

9. Method according to claim 8, wherein, at the date t_{c}, counting the number N_{ECM} of successfully processed contemporary ECM messages comprises the following operations:
comparing the date t with the date (t_{c}−T_{Diff}),
increasing the number N_{ECM} if the date (t_{c}−T_{Diff}) is less than or equal to the date t, otherwise maintaining the number N_{ECM} at the current value,
if the date t is between the date t_{c} and the date t_{c}+T_{InaMin}, increasing the period of activity T_{Act} by the value (t−t_{c}), otherwise maintaining the period of activity T_{Act} at the current value.

10. Method according to claim 7, wherein, during an observation period starting at an instant tₒ, the analysis of security processor use comprises the following operations:
calculating the relationship M_{ECM}=N_{ECM}/T_{Act},
checking whether T_{Act} is greater than or equal to a preset duration T_{ActMin} and whether M_{ECM} is greater than Sₘₐₓ,
if yes,
applying the sanction,
increasing the number n of sanctions and/or the level of the
sanction applied,
reinitialising the values N_{ECM}, T_{Act} and tₒ.
otherwise,
decrypting the control word CW,
if the duration (t−tₒ) is greater than the duration T_{obs} of the observation period,
reinitialising the values of N_{ECM}, T_{Act} and tₒ
if the date t is greater than the date t_{c}
replacing the date t_{c} by the date t.

11. Method according to claim 10, wherein, when the number of ECM messages successfully processed during the period T_{obs} has been increased by a preset threshold value N_{Buf}, the parameters N_{ECM}, tₒ and T_{Act} are transferred into an EEPROM memory.

12. Method according to claim 1, wherein analysis parametensation and activation can be programmed by an operator by sending an EMM message.

13. Method according to claim 12, wherein said EMM message carries at least one of the following parameters:
the duration T_{obs} of the observation period,
the minimum duration of activity T_{ActMin},
the delay T_{Diff},
the minimum duration of inactivity T_{InaMin},
the threshold value Sₘₐₓ,
the threshold value N_{Buf}.

14. Security processor intended to control access to a scrambled digital content supplied by at least one operator to at least one receiving terminal, characterised in that it comprises:
a first module for analysing its use during a preset observation period T_{obs},
a second module for determining on the basis of said analysis the mean value M_{ECM} of the number of invitations per time unit of said security processor during said observation period T_{obs} and for comparing said mean value M_{ECM} with a preset threshold Sₘₐₓ, and
a third module for applying to said terminal a sanction whereof the level of severity progressively increases if the mean value M_{ECM} is greater than the threshold Sₘₐₓ.

15. Computer program including program code instructions for implementing steps in the method according to claim 1 when said program is run on a security processor associated with a terminal for receiving digital contents supplied by an operator, characterised in that it comprises:
instructions for analysing the use of said chip card by said terminal over a preset observation period T_{Obs},
instructions for determining on the basis of said analysis the mean value M_{ECM} of the number of invocations per time unit of said chip card by said terminal during said observation period T_{obs} and for comparing said mean value M_{ECM} with a preset threshold Sₘₐₓ, and
instructions for applying to said terminal a sanction whereof the level of severity progressively increases if the mean value M_{ECM} is greater than the threshold Sₘₐₓ.

16. Method according to claim 5, wherein analysis parameterisation and activation can be programmed by an operator by sending an EMM message.

17. Method according to claim 16, wherein analysis parameterisation and activation can be programmed by an operator by sending an EMM message.

18. Computer program including program code instructions for implementing steps in the method according to claim 5 when said program is run on a security processor associated with a terminal for receiving digital contents supplied by an operator, characterised in that it comprises:
instructions for analysing the use of said chip card by said terminal over a preset observation period T_{obs},
instructions for determining on the basis of said analysis the mean value M_{ECM} the number of invocations per time unit of said chip card by said terminal during said observation period T_{obs} and for comparing said mean value M_{ECM} with a preset threshold Sₘₐₓ, and
instructions for applying to said terminal a sanction whereof the level of severity progressively increases if the mean value M_{ECM} is greater than the threshold Sₘₐₓ.

19. Computer program including program code instructions for implementing steps in the method according to claim 7 when said program is run on a security processor associated with a terminal for receiving digital contents supplied by an operator, characterised in that it comprises:
instructions for analysing the use of said chip card by said terminal over a preset observation period T_{Obs},
instructions for determining on the basis of said analysis the mean value M_{ECM} of the number of invocations per time unit of said chip card by said terminal during said observation period T_{obs} and for comparing said mean value M_{ECM} with a preset threshold Sₘₐₓ, and
